(19) United States
(12) Patent Application Publication
(10) Pub. No.: US 2026/0252018 A1
(43) Pub. Date: Aug. 27, 2026

(54) POSTPROCESSING DEVICE AND IMAGE FORMING APPARATUS

(71) Applicant: FUJIFILM Business Innovation Corp., Tokyo (JP)

(72) Inventors: Takumi UEGANE, Kanagawa (JP); Takuya MAKITA, Kanagawa (JP); Jun SHIBUYA, Kanagawa (JP); Akira ITO, Kanagawa (JP); Hideki KAYASHIMA, Kanagawa (JP)

(73) Assignee: FUJIFILM Business Innovation Corp., Tokyo (JP)

(21) Appl. No.: 19/305,063

(22) Filed: Aug. 20, 2025

(30) Foreign Application Priority Data
Feb. 26, 2025 (JP) 2025-028894

(51) Int. Cl. G03G 15/00

(52) U.S. Cl. CPC G03G 15/6544; G03G 2215/00556

(57) ABSTRACT

A postprocessing device includes a binder that binds media; a guided member disposed at the binder; a guide member that guides the guided member disposed at the binder, the guide member including a first guide portion that extends in a width direction of the media, a second guide portion that is connected to the first guide portion and extends in a direction inclined with respect to the width direction, and a third guide portion that is connected to the second guide portion and extends in a direction inclined with respect to the direction in which the second guide portion extends; and a control member that controls movement of the binder along the guide member, and controls the binder to move the guided member in the second guide portion and the third guide portion at a lower speed than when moving the guided member in the first guide portion.

### CROSS-REFERENCE TO RELATED APPLICATIONS

This application is based on and claims priority under 35 USC 119 from Japanese Patent Application No. 2025-028894 filed Feb. 26, 2025.

### BACKGROUND

### (i) Technical Field

The present disclosure relates to a postprocessing device and an image forming apparatus including a postprocessing device.

### (ii) Related Art

Technologies relating to binding devices that bind a stack of media on which images are recorded by an image recording device, generally referred to as stapler devices, are described in Japanese Unexamined Patent Application Publication No. 2024-15984 (FIGS. 1, 2, 7, and 8), and No. 2023-64831 (FIGS. 1 to 5) to be publicly known.

Japanese Unexamined Patent Application Publication No. 2024-15984 (FIGS. 1, 2, 7, and 8) describes a structure including a receiving tray (300) that is obliquely inclined with respect to the gravitation direction, and on which a stack of media is loaded, a staple unit (400) that binds a stack of media, that is inclined with respect to the gravitation direction corresponding to the inclination of the receiving tray (300), and that is guided along a cam groove (430) inclined with respect to the gravitation direction.

Japanese Unexamined Patent Application Publication No. 2023-64831 (FIGS. 1 to 5) describes a structure including a slant tray (60) that is obliquely inclined with respect to the gravitation direction, and on which a stack of media is loaded, a binding unit (61) that binds a stack of media, that is inclined with respect to the gravitation direction corresponding to the inclination of the slant tray (60), and that is guided along grooves (621 and 622) of a shaft guide mechanism (62) inclined with respect to the gravitation direction.

### SUMMARY

Aspects of non-limiting embodiments of the present disclosure relate to a binder that causes fewer failures while moving than a binder that moves at a constant speed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a postprocessing device including
a binder that binds media;
a guided member disposed at the binder;
a guide member that guides the guided member disposed at the binder, the guide member including a first guide portion that extends in a width direction of the media, a second guide portion that is connected to the first guide portion and extends in a direction inclined with respect to the width direction, and a third guide portion that is connected to the second guide portion and extends in a direction inclined with respect to the direction in which the second guide portion extends; and
a control member that controls movement of the binder along the guide member, and controls the binder to move the guided member in the second guide portion and the third guide portion at a lower speed than when moving the guided member in the first guide portion.

### BRIEF DESCRIPTION OF THE DRAWINGS

Exemplary embodiments of the present disclosure will be described in detail based on the following figures, wherein:

FIG. 1 is a diagram of the entirety of an image forming apparatus according to a first example;

FIG. 2 is a diagram of a related portion of an image recording portion according to the first example;

FIG. 3 is a plan view of a postprocessing device according to a first example;

FIGS. 4A and 4B are diagrams of a related portion of a guide member and a switching member according to the first example, where FIG. 4A is a plan view of a rear portion, and FIG. 4B is a perspective view of the rear portion viewed in a direction of arrow IVB in FIG. 4A;

FIGS. 5A, 5B, and 5C are diagrams of a switching member according to the first example, where FIG. 5A is a perspective view of the switching member, FIG. 5B is a diagram of the switching member that is moved to a second guide position, and FIG. 5C is a diagram of the switching member that is moved to a third guide position;

FIGS. 6A and 6B are diagrams of a guide member and the switching member according to the first example, where FIG. 6A is a diagram of the switching member that is moved to the second guide position, and FIG. 6B is a diagram of the switching member that is moved to the third guide position;

FIGS. 7A and 7B are diagrams of a staple unit according to the first example, where FIG. 7A is a diagram of a stapleless staple unit, and FIG. 7B is a diagram of a staple-using staple unit;

FIGS. 8A, 8B, 8C, and 8D are diagrams describing movement of the stapleless staple unit according to the first example, where FIG. 8A is a diagram of the stapleless staple unit that is moved to an edge-binding position, FIG. 8B is a diagram of the stapleless staple unit that is moved to a rear-corner-binding position, FIG. 8C is a diagram of the stapleless staple unit that is moved to a retraction position, and FIG. 8D is a diagram of the stapleless staple unit while the stapleless staple unit is being moved forward from the retraction position;

FIG. 9 is a diagram of the stapleless staple unit according to the first example, while the stapleless staple unit is being moved from the rear-corner-binding guide portion to a retraction connection portion;

FIG. 10 is a diagram describing movement of the staple-using staple unit according to the first example;

FIG. 11 is a functional block diagram of a control portion according to the first example;

FIGS. 12A and 12B are diagrams of positions of binding devices according to the first example, where FIG. 12A is a diagram of the binding devices in non-operational positions, and FIG. 12B is a diagram of the binding devices in positions to perform an aligning process;

FIGS. 13A and 13B are diagrams describing positions of the binding devices according to the first example to perform staple-using corner binding, where FIG. 13A is a diagram of the binding devices in positions for sheet delivery, and FIG. 13B is a diagram of the binding devices that are moved to staple-using corner binding positions;

FIGS. 14A, 14B, and 14C are diagrams describing positions of the binding devices according to the first example to perform staple-using edge binding, where FIG. 14A is a diagram of the binding devices in positions for sheet delivery, FIG. 14B is a diagram of the binding devices during a first shot in staple-using edge binding, and FIG. 14C is a diagram of the binding devices during a second shot in staple-using edge binding;

FIGS. 15A, 15B, and 15C are diagrams of positions of the binding devices according to the first example to perform stapleless corner binding, where FIG. 15A is a diagram of the binding devices that have passed a switching member before sheet delivery, FIG. 15B is a diagram of the binding devices in positions for sheet delivery, and FIG. 15C is a diagram of the binding devices that are moved to a stapleless corner binding position; and

FIGS. 16A, 16B, and 16C are diagrams of positions of the binding devices according to the first example to perform stapleless edge binding, where FIG. 16A is a diagram of the binding devices in positions for sheet delivery, FIG. 16B is a diagram of the binding devices during a first shot in stapleless edge binding, and FIG. 16C is a diagram of the binding devices during a second shot in stapleless edge binding.

### DETAILED DESCRIPTION

With reference now to the drawings, examples serving as specific examples of exemplary embodiments of the present disclosure are described, but the present disclosure is not limited to the examples described below.

For easy understanding of the description below, throughout the drawings, an X-axis direction denotes the front-rear direction, a Y-axis direction denotes the lateral direction, and a Z-axis direction denotes the vertical direction. The directions or sides indicated by arrows X, −X, Y, −Y, Z, and −Z are respectively referred to as forward, rearward, rightward, leftward, upward, and downward, or a front side, a rear side, a right side, a left side, an upper side, and a lower side.

Throughout the drawings, an encircled dot denotes an arrow directing from the back to the front of the sheet, and an encircled cross denotes an arrow directing from the front to the back of the sheet.

In the description with reference to the drawings, components other than those needed for the description are omitted as appropriate for ease of understanding.

### First Example

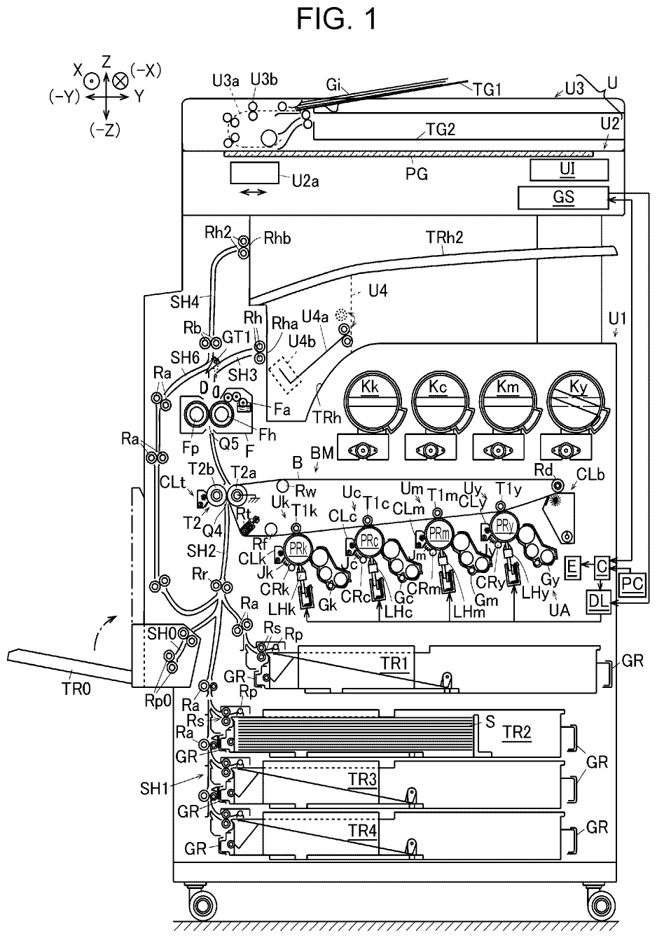

FIG. 1 illustrates the entirety of an image forming apparatus according to a first example.

In FIG. 1, a copying machine U serving as an example of the image forming apparatus according to the first example of the present disclosure includes a printer portion U1, serving as an example of an image recorder and an example of the image forming apparatus. The printer portion U1 supports, at an upper portion, a scanner portion U2, serving as an example of a reading unit and an example of an image reading device. The scanner portion U2 supports, at an upper portion, an auto-feeder U3 serving as an example of a document transporting device.

At an upper portion of the auto-feeder U3, a document tray TG1, serving as an example of a medium container, is disposed. The document tray TG1 is capable of receiving a stack of multiple documents Gi that are to be copied. Below the document tray TG1, a document exit tray TG2 serving as an example of a document exit portion is disposed. Between the document tray TG1 and the document exit tray TG2, document transport rollers U3b are disposed along a document transport path U3a.

At the upper surface of the scanner portion U2, a platen glass PG serving as an example of a transparent document table is disposed. The scanner portion U2 according to the first example includes a reading unit U2a, which serves as an example of a reader and is disposed below the platen glass PG. The reading unit U2a according to the first example is supported to be movable in a lateral direction, serving as an example of a sub-scanning direction, along the lower surface of the platen glass PG. The reading unit U2a is electrically connected to an image processor GS.

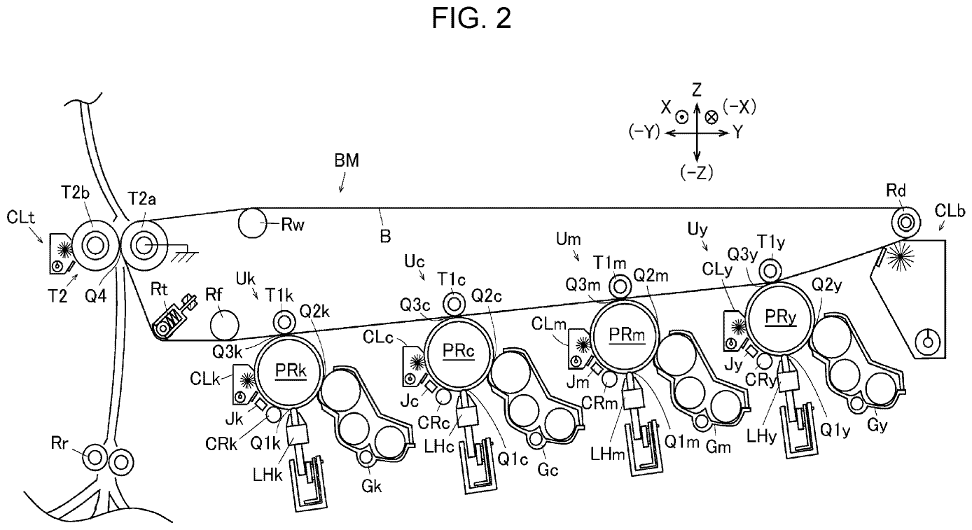

FIG. 2 is a diagram of a related portion of an image recording portion according to the first example.

The image processor GS is electrically connected to a write circuit DL in the printer portion U1. The write circuit DL is electrically connected to writing devices LHy, LHm, LHc, and LHk serving as examples of latent image forming devices.

The writing devices LHy to LHk according to the first example each include, for example, a light emitting diode (LED) head including multiple LEDs arranged in a main scanning direction. The writing devices LHy to LHk are capable of outputting write light beams corresponding to colors of yellow (Y), magenta (M), cyan (C), and black (K) in accordance with signals input from the write circuit DL.

The write circuit DL or a power source circuit E are controlled in terms of write timing or power supply timing in accordance with control signals from a controller C serving as an example of a control member.

In FIG. 1, above the writing devices LHy to LHk, photoconductors PRy, PRm, PRc, and PRk serving as examples of image carriers are disposed. In FIG. 1 and FIG. 2, the areas of the photoconductors PRy to PRk irradiated with write light constitute write areas Q1y, Q1m, Q1c, and Q1k.

Upstream from the write areas Q1y to Q1k in rotation directions of the photoconductors PRy to PRk, charging rollers CRy, CRm, CRc, and CRk serving as examples of chargers are respectively disposed. The charging rollers CRy to CRk according to the first example are supported to be rotatably driven while being in contact with the photoconductors PRy to PRk.

Downstream from the write areas Q1y to Q1k in the rotation directions of the photoconductors PRy to PRk, developing devices Gy, Gm, Gc, and Gk serving as examples of developing members are respectively disposed. Areas where the photoconductors PRy to PRk and the developing devices Gy to Gk respectively face one another constitute development areas Q2y, Q2m, Q2c, and Q2k.

Downstream from the developing devices Gy to Gk in the rotation directions of the photoconductors PRy to PRk, first transfer rollers T1y, T1m, T1c, and T1k serving as examples of first transfer members are respectively disposed. Areas where the photoconductors PRy to PRk and the first transfer rollers T1y to T1k respectively face one another constitute first transfer areas Q3y, Q3m, Q3c, and Q3k.

Downstream from the first transfer rollers T1y to T1k in the rotation directions of the photoconductors PRy to PRk, photoconductor cleaners CLy, CLm, CLc, and CLk serving as examples of cleaners are respectively disposed.

Downstream from the photoconductor cleaners CLy to CLk in the rotation directions of the photoconductors PRy to PRk, static eliminators Jy, Jm, Jc, and Jk serving as examples of static eliminating members or examples of static eliminating devices are respectively disposed.

The photoconductor PRy, the charging roller CRy, the writing device LHy, the developing device Gy, the first transfer roller T1y, the photoconductor cleaner CLy, and the static eliminator Jy for the color Y constitute an image forming portion Uy for the color Y serving as an example of a visible image forming member for the color Y according to the first example that forms toner images of the color Y. Similarly, each of the photoconductors PRm, PRc, and PRk, the corresponding one of the charging rollers CRm, CRc, and CRk, the corresponding one of the writing devices LHm, LHc, and LHk, the corresponding one of the developing devices Gm, Gc, and Gk, the corresponding one of the first transfer rollers T1m, T1c, and T1k, the corresponding one of the photoconductor cleaners CLm, CLc, and CLk, and the corresponding one of the static eliminators Jm, Jc, and Jk constitute an image forming portion Um, Uc, or Uk for the corresponding one of the colors M, C, and K.

Above the photoconductors PRy to PRk, a belt module BM serving as an example of an intermediate transfer device is disposed. The belt module BM includes an intermediate transfer belt B serving as an example of an image carrier and an example of an intermediate transfer member. The intermediate transfer belt B is formed from an endless belt.

The intermediate transfer belt B according to the first example is rotatably supported by a tension roller Rt serving as an example of a tensioner, a walking roller Rw serving as an example of an imbalance corrector, an idler roller Rf serving as an example of a driven member, a backup roller T2a serving as an example of an opposing member opposing a second transfer area, the first transfer rollers T1y to T1k, and a driving roller Rd serving as an example of a driving member. In the first example, when a driving force is transmitted to the driving roller Rd, the intermediate transfer belt B rotates.

At a position facing the backup roller T2a across the intermediate transfer belt B, a second transfer roller T2b serving as an example of a second transfer member is disposed. Components including the backup roller T2a and the second transfer roller T2b constitute a second transfer device T2 according to the first example serving as an example of a transfer device. The area where the second transfer roller T2b and the intermediate transfer belt B are in contact constitutes a second transfer area Q4.

Downstream from the second transfer area Q4 in the rotation direction of the intermediate transfer belt B, a belt cleaner CLb is disposed as an example of a cleaning device to clean the intermediate transfer body.

Components including the first transfer rollers T1y to T1k, the intermediate transfer belt B, and the second transfer device T2 constitute a transfer device T1+T2+B serving as an example of a transfer member according to the first example. The image forming portions Uy to Uk and the transfer device T1+T2+B constitute an image recording portion Uy-Uk+T1+T2+B according to the first example.

In FIG. 1, below the image forming portions Uy to Uk, four pairs of left and right guide rails GR serving as examples of guide members are disposed. On the guide rails GR, sheet feeding trays TR1, TR2, TR3, and TR4 serving as examples of medium containers are supported to be movable in and out in a front-rear direction. The sheet feeding trays TR1 to TR4 receive recording paper sheets S serving as examples of media.

At the upper left of each of the sheet feeding trays TR1 to TR4, a pickup roller Rp serving as an example of a pickup member is disposed. Downstream from the pickup roller Rp in the transport direction of the recording paper sheet S, separation rollers Rs serving as examples of separation members are disposed. Downstream from the separation rollers Rs in the transport direction of the recording paper sheet S, a sheet feeding path SH1 extending upward is disposed as an example of a medium transport path. Multiple transport rollers Ra serving as examples of transport members are disposed on the sheet feeding path SH1.

At a lower left of the copying machine U, a manual feed tray TR0 serving as an example of a medium container is disposed. At an upper right of the manual feed tray TR0, pickup rollers Rp0 are disposed, and a manual sheet feeding path SH0 extends. The manual sheet feeding path SH0 merges into the sheet feeding path SH1.

On the sheet feeding path SH1, upstream from the second transfer area Q4, registration rollers Rr serving as examples of adjusters of a transport timing are disposed. A transport path SH2 extends from the registration rollers Rr toward the second transfer area Q4.

Downstream from the second transfer area Q4 in the transport direction of the recording paper sheet S, a fixing device F serving as an example of a fixing member is disposed. The fixing device F includes a heating roller Fh serving as an example of a fixing member for heating, and a pressing roller Fp serving as an example of a fixing member for pressing. A contact area where the heating roller Fh and the pressing roller Fp are in contact constitutes a fixing area Q5.

At an upper surface of the printer portion U1, a lower paper exit tray TRh serving as an example of a medium exit portion is disposed. In the first example, at the lower paper exit tray TRh, a finisher U4 serving as an example of a postprocessing device is disposed. Above the fixing device F, a sheet exit path SH3 serving as an example of a transport path extends toward the lower paper exit tray TRh. At the downstream end of the sheet exit path SH3, discharging rollers Rh serving as examples of medium transporting members are disposed.

Above the lower paper exit tray TRh, an upper paper exit tray TRh2 serving as an example of a medium exit portion is disposed. Above the fixing device F, an upper transport path SH4 that diverges from the sheet exit path SH3 to extend toward the upper paper exit tray TRh2 is disposed.

On the upper transport path SH4, reverse rollers Rb serving as examples of medium transporting members rotatable forward and backward are disposed. Above a position where the sheet exit path SH3 and the upper transport path SH4 diverge, a reverse path SH6 serving as an example of a medium transport path diverges to the lower left from the upper transport path SH4.

A gate GT1 serving as an example of a switching member is disposed across a diverging portion at which the sheet exit path SH3 and the upper transport path SH4 diverge and a diverging portion at which the upper transport path SH4 and the reverse path SH6 diverge. The gate GT1 is supported to be switchable between a first guide position (a second position) to guide the recording paper sheet S from the fixing device F toward the lower paper exit tray TRh, and to guide the recording paper sheet S from the upper transport path SH4 to the reverse path SH6, and a second guide position (a first position) to guide the recording paper sheet S from the fixing device F toward the upper transport path SH4.

Multiple transport rollers Ra serving as examples of medium transport members are disposed on the reverse path SH6. The downstream end of the reverse path SH6 merges into the sheet feeding path SH1 upstream from the registration rollers Rr.

### Description of Image Forming Operation

When an operator manually places a document Gi on the platen glass PG to perform copying with the copying machine U according to the first example with the above structure, the reading unit U2a moves in the lateral direction from the initial position to scan the document Gi on the platen glass PG while exposing the document Gi with light. When the auto-feeder U3 is used to automatically transport documents Gi for photocopying, the multiple documents Gi received on the document tray TG1 are sequentially transported to and pass a document read position on the platen glass PG, and discharged to the document exit tray TG2. The documents Gi sequentially passing the read position on the platen glass PG are irradiated by the reading unit U2a with light to be scanned. Reflection light reflected off the documents Gi is received by the reading unit U2a. The reading unit U2a converts the received reflection light reflected off the documents Gi into electric signals. To perform both-side reading of the documents Gi, the documents Gi are also read by a reading sensor.

The image processor GS receives an input of electric signals output from the reading unit U2a. The image processor GS converts the electric signals of images of the colors R, G, and B read by the reading unit U2a into image information of yellow (Y), magenta (M), cyan (C), and black (K) for forming latent images. The image processor GS outputs the image information obtained after the conversion to the write circuit DL. To form a single-color image or a monochrome image as the image, the image processor GS outputs the image information of only black (K) to the write circuit DL.

The write circuit DL outputs control signals corresponding to the input image information to the writing devices LHy to LHk. The writing devices LHy to LHk output write light corresponding to the control signals.

Each of the photoconductors PRy to PRk is driven to rotate when the image formation is started. A charging voltage is applied to the charging rollers CRy to CRk from the power source circuit E. The surfaces of the photoconductors PRy to PRk are thus electrically charged by the charging rollers CRy to CRk. In the write areas Q1y to Q1k on the surfaces of the electrically charged photoconductors PRy to PRk, electrostatic latent images are formed by the writing devices LHy to LHk. The electrostatic latent images on the photoconductors PRy to PRk are developed into toner images, serving as examples of visible images, by the developing devices Gy to Gk in the development areas Q2y to Q2k.

The developed toner images are transported to the first transfer areas Q3y to Q3k at which the toner images come into contact with the intermediate transfer belt B, serving as an example of an intermediate transfer member. In the first transfer areas Q3y to Q3k, a first transfer voltage with a polarity opposite to the charging polarity of toner is applied from the power source circuit E to the first transfer rollers T1y to T1k. The toner images on the photoconductors PRy to PRk are thus transferred to the intermediate transfer belt B by the first transfer rollers T1y to T1k. To form a multi-color toner image, a toner image on the downstream side is transferred, in a superposed manner, onto a toner image that has been transferred to the intermediate transfer belt B in the upstream first transfer area.

Remnants or accretions on the photoconductors PRy to PRk that have undergone first transfer are removed by the photoconductor cleaners CLy to CLk. The surfaces of the cleaned photoconductors PRy to PRk undergo static elimination by the static eliminators Jy to Jk. The surfaces of the photoconductors PRy to PRk that have undergone static elimination are electrically charged again by the charging rollers CRy to CRk.

The single-color or multi-color toner image transferred onto the intermediate transfer belt B by the first transfer rollers T1y to T1k in the first transfer areas Q3y to Q3k is transported to the second transfer area Q4.

The recording paper sheet S on which an image is to be recorded is picked up by any of the pickup rollers Rp at the sheet feeding trays TR1 to TR4 to be used. When multiple recording paper sheets S are collectively picked up by the pickup roller Rp in a stacked manner, the multiple recording paper sheets S are separated one from another by the separation rollers Rs. The recording paper sheets S separated by the separation rollers Rs are transported by the transport rollers Ra along the sheet feeding path SH1. The recording paper sheets S transported along the sheet feeding path SH1 are transported to the registration rollers Rr. The recording paper sheets S loaded on the manual feed tray TR0 are also transported to the sheet feeding path SH1 through the manual sheet feeding path SH0 by the pickup rollers Rp0.

The registration rollers Rr transport the recording paper sheet S to the second transfer area Q4 at the timing when the toner image formed on the intermediate transfer belt B is transported to the second transfer area Q4. A second transfer voltage having a polarity opposite to the charging polarity of the toner is applied to the second transfer roller T2b by the power source circuit E. The toner image on the intermediate transfer belt B is thus transferred to the recording paper sheet S from the intermediate transfer belt B.

Accretions or other matter adhering to the surface of the intermediate transfer belt B that has undergone second transfer are removed by the belt cleaner CLb. The second transfer roller T2b is cleaned by a second transfer cleaner CLt serving as an example of a second transfer cleaning device.

The recording paper sheet S to which the toner image is second transferred undergoes fixing with heat when passing the fixing area Q5.

When the recording paper sheet S to which an image is fixed is to undergo postprocessing, the recording paper sheet S is transported to the finisher U4 disposed at the lower paper exit tray TRh. When the recording paper sheet S is not to undergo postprocessing, the recording paper sheet S is transported to the upper paper exit tray TRh2. To transport the recording paper sheet S to the lower paper exit tray TRh, the gate GT1 moves to the first guide position. Thus, the recording paper sheet S fed from the fixing device F is transported along the sheet exit path SH3. The recording paper sheet S transported along the sheet exit path SH3 is transported by the discharging rollers Rh toward the finisher U4 and the lower paper exit tray TRh.

After performing a binding process, serving as an example of postprocessing, on the recording paper sheet S, the finisher U4 discharges the recording paper sheet S to the lower paper exit tray TRh.

To discharge the recording paper sheet S to the upper paper exit tray TRh2, the gate GT1 moves to the second guide position. The recording paper sheet S is discharged by second discharging rollers Rh2 through an upper paper exit port Rhb to the upper paper exit tray TRh2.

To perform two-side printing on the recording paper sheet S, the gate GT1 moves to the second guide position. When the trailing end of the recording paper sheet S passes the gate GT1, the gate GT1 moves to the first guide position, and the reverse rollers Rb rotate in the reverse direction. Thus, the recording paper sheet S is guided by the gate GT1 to be transported to the reverse path SH6. The recording paper sheet S transported along the reverse path SH6 is transported to the registration rollers Rr while being turned upside down.

### Description of Finisher U4

In FIG. 1, the finisher U4 according to the first example includes a compile tray U4a serving as an example of a receiving member. Upstream from the compile tray U4a in a medium transport direction, a staple device U4b serving as an example of a binding device is disposed.

Downstream from the compile tray U4a in the medium transport direction, the lower paper exit tray TRh is disposed.

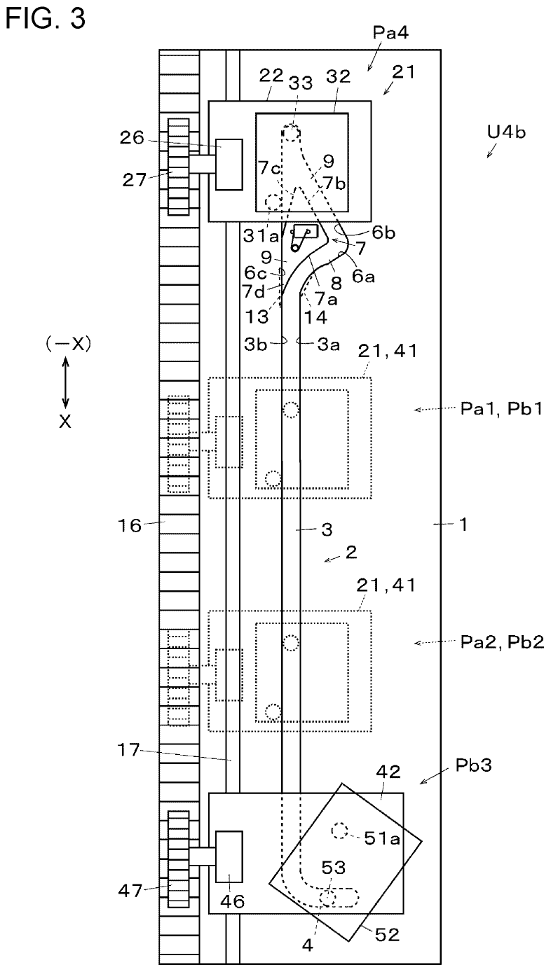

FIG. 3 is a plan view of a postprocessing device according to the first example.

In FIG. 3, the staple device U4b according to the first example includes a guide plate 1 serving as an example of a guide member. In the first example, the entirety of the guide plate 1 is disposed to have the left side located lower in the gravitation direction than the right side closer to the compile tray U4a. In other words, the guide plate 1 is inclined toward the lower left. To align the edges of recording paper sheets S loaded on the compile tray U4a, the compile tray U4a is inclined toward the lower left, and the guide plate 1 is also preferably inclined toward the lower left, but this is not the only possible example. The guide plate 1 may be disposed horizontally, or inclined toward the lower right.

The guide plate 1 has a guide groove 2 serving as an example of a guide member. The guide groove 2 according to the first example is an example of a first guide portion, and includes an edge-binding guide portion 3 extending in the front-rear direction as an example of a common guide portion. To the front end of the edge-binding guide portion 3, a front-corner binding guide portion 4 serving as an example of a fifth guide portion is connected. The front-corner binding guide portion 4 is inclined and bent into an arc at the right.

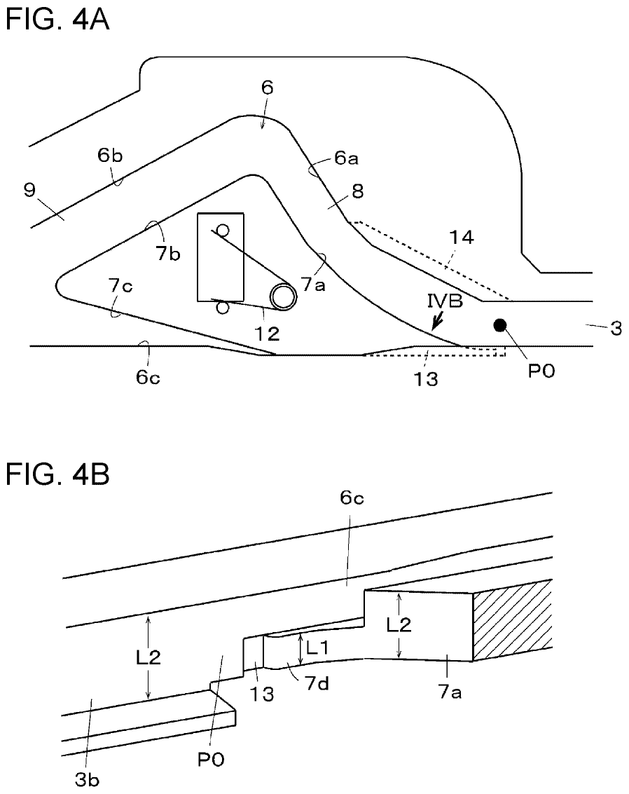

FIGS. 4A and 4B are diagrams of a related portion of a guide member and a switching member according to the first example, where FIG. 4A is a plan view of a rear portion, and FIG. 4B is a perspective view of the rear portion viewed in a direction of arrow IVB in FIG. 4A.

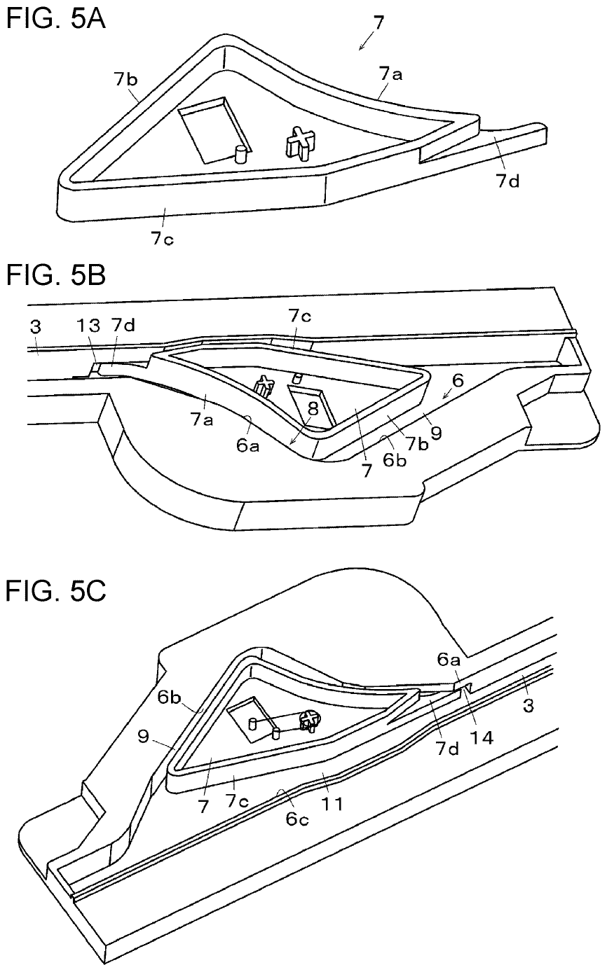

FIGS. 5A, 5B, and 5C are diagrams of a switching member according to the first example, where FIG. 5A is a perspective view of the switching member, FIG. 5B is a diagram of the switching member that is moved to a second guide position, and FIG. 5C is a diagram of the switching member that is moved to a third guide position.

In FIGS. 4A and 4B and FIGS. 5A, 5B, and 5C, at the rear end portion of the edge-binding guide portion 3, a protuberance 6 protrudes to the right with respect to the extension of the edge-binding guide portion 3, or in other words, to the inside in the compile tray U4a. The protuberance 6 includes, at the right portion, a first protuberance right wall 6a that is connected to a right wall 3a of the edge-binding guide portion 3 and that extends obliquely rearward to the right in an arc shape. The protuberance 6 further includes, at the rear end of the first protuberance right wall 6a, a second protuberance right wall 6b that extends obliquely rearward to the left. The protuberance 6 further includes, at the left portion, a protuberance left wall 6c that is connected to a left wall 3b of the edge-binding guide portion 3. The protuberance left wall 6c according to the first example extends rectilinearly rearward on the extension of the left wall 3b of the edge-binding guide portion 3.

Inside the protuberance 6, a switching gate 7 serving as an example of a switching member is disposed. The switching gate 7 according to the first example includes a first gate wall 7a serving as an example of a first switch wall. The first gate wall 7a is disposed to face the first protuberance right wall 6a. Thus, the first gate wall 7a extends obliquely rearward to the right from the front end in an arc shape. The switching gate 7 further includes, at the rear end portion of the first gate wall 7a, a second gate wall 7b serving as an example of a second switch wall. The second gate wall 7b is disposed to face the second protuberance right wall 6b. Thus, the second gate wall 7b extends obliquely rearward to the left from the front end. The switching gate 7 includes a third gate wall 7c serving as an example of a third switch wall. The third gate wall 7c is disposed to face the protuberance left wall 6c. Thus, the third gate wall 7c extends rearward from the front end. The third gate wall 7c is disposed to connect the front end of the first gate wall 7a to the rear end of the second gate wall 7b. Thus, the switching gate 7 according to the first example has a substantially triangular shape as a whole.

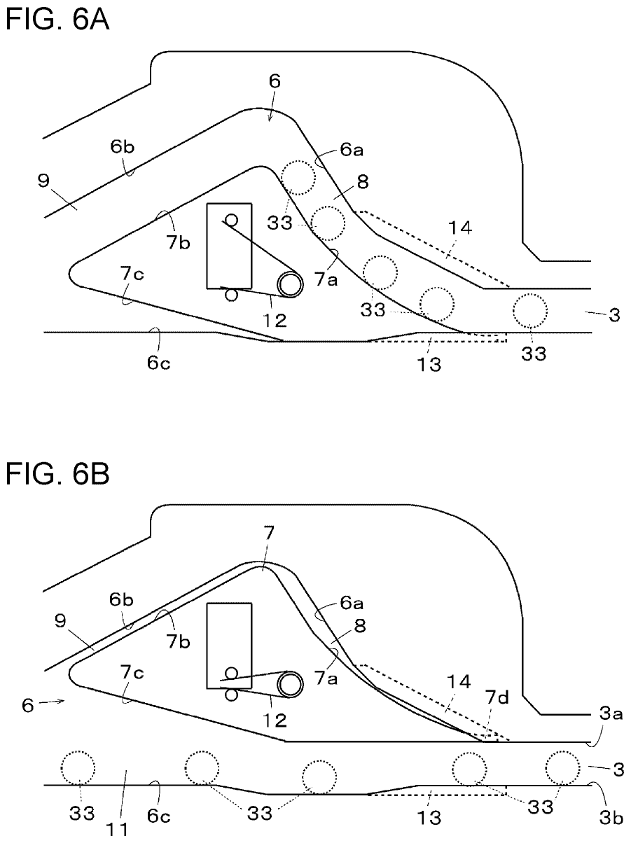

FIGS. 6A and 6B are diagrams of a guide member and the switching member according to the first example, where FIG. 6A is a diagram of the switching member that is moved to the second guide position, and FIG. 6B is a diagram of the switching member that is moved to the third guide position.

The switching gate 7 is supported to be rectilinearly movable in the lateral direction, that is, in a direction toward the inner side or the outer side of the compile tray U4a. The switching gate 7 according to the first example is supported to be movable between the second guide position (refer to FIGS. 5B and 6A) to the left (the outer side of the compile tray U4a) and the third guide position (refer to FIGS. 5C and 6B) to the right (the inner side of the compile tray U4a).

In FIGS. 5B and 6A, in the second guide position, a rear-corner-binding guide portion 8 serving as an example of the second guide portion is defined by the first gate wall 7a of the switching gate 7 and the first protuberance right wall 6a of the protuberance 6. In the second guide position, a retraction connection portion 9 serving as an example of the third guide portion is defined by the second gate wall 7b of the switching gate 7 and the second protuberance right wall 6b of the protuberance 6. More specifically, when the switching gate 7 moves to the second guide position, the rear-corner-binding guide portion 8 and the retraction connection portion 9 serving as the guide grooves 2 are defined by the switching gate 7 and the right walls 6a and 6b of the protuberance 6.

In FIGS. 5C and 6B, in the third guide position, a retraction guide portion 11 serving as an example of a fourth guide portion is defined by the third gate wall 7c of the switching gate 7 and the protuberance left wall 6c of the protuberance 6. More specifically, when the switching gate 7 moves to the third guide position, the retraction guide portion 11 serving as the guide groove 2 is defined by the switching gate 7 and the protuberance left wall 6c.

The edge-binding guide portion 3, the front-corner binding guide portion 4, the rear-corner-binding guide portion 8, the retraction connection portion 9, and the retraction guide portion 11 form the guide grooves 2 according to the first example.

The switching gate 7 according to the first example is urged toward the third guide position by a torsion spring 12 serving as an example of an urging member.

The switching gate 7 includes a junction portion 7d at the front end portion. The junction portion 7d is located at a position where the rear-corner-binding guide portion 8 and the retraction guide portion 11 diverge (at a junction position P0).

Thus, the junction portion 7d according to the first example is located at a position closer to the junction position P0 than to the gate walls 7a and 7c. In other words, the gate walls 7a and 7c serving as examples of switch guide portions are located at positions farther from the junction position P0 than the junction portion 7d.

In FIG. 4B, the junction portion 7d according to the first example has a height L1 in the height direction that is shorter than a height L2 of a component different from the junction portion 7d. In the switching gate 7 according to the first example, the height L1 is lower at the junction portion 7d than at other portions, and the height L2 is higher at the gate walls 7a to 7c serving as other components. More specifically, in the first example, the gate walls 7a to 7c and the right walls 6a and 6b and the left wall 6c of the protuberance 6 have the same height L2, and only the junction portion 7d has the lower height L1.

In FIGS. 4B and 5B, the protuberance left wall 6c has a first receiving recess 13 serving as an example of an accommodation member. The first receiving recess 13 has a height capable of receiving the junction portion 7d. Thus, the height of the first receiving recess 13 is higher than the junction portion 7d and lower than the protuberance left wall 6c. In other words, in the second guide position, the junction portion 7d is recessed leftward (outward from the compile tray U4a) beyond the right surface of the protuberance left wall 6c. In addition, the first receiving recess 13 has a longer length in the front-rear direction than the junction portion 7d. Thus, when the switching gate 7 is moved to the second guide position, the junction portion 7d is received in the first receiving recess 13. Thus, compared to when the first receiving recess 13 is shorter than or has the same length as the junction portion 7d, the first receiving recess 13 is capable of reliably receiving the junction portion 7d to reduce bumps regardless of when the junction portion 7d has, for example, manufacturing errors or backlash. In the first example, when the junction portion 7d is received in the first receiving recess 13, the right surface of the junction portion 7d (outer surface closer to the first protuberance right wall 6a) and the surface of the protuberance left wall 6c (guide surface) are flush with each other. More specifically, no bumps are formed between the right surface of the junction portion 7d and the surface of the protuberance left wall 6c.

In FIG. 5C, the first protuberance right wall 6a has a second receiving recess 14 serving as an example of a second accommodation member. As in the case of the first receiving recess 13, the second receiving recess 14 has a height capable of receiving the junction portion 7d. The height of the second receiving recess 14 is higher than the junction portion 7d and lower than the first protuberance right wall 6a. The second receiving recess 14 is longer in length in the front-rear direction than the junction portion 7d. Thus, when the switching gate 7 is moved to the third guide position, the junction portion 7d is received in the second receiving recess 14 (refer to FIGS. 5C and 6B).

In the first example, when the junction portion 7d is received in the second receiving recess 14, the left surface of the junction portion 7d (outer surface closer to the protuberance left wall 6c) and the surface of the first protuberance right wall 6a (guide surface) are flush with each other. More specifically, no bumps are formed between the left surface of the junction portion 7d and the surface of the first protuberance right wall 6a.

In FIG. 3, rack teeth 16 serving as examples of driving members are arranged at the left end portion of the guide plate 1. The rack teeth 16 according to the first example include a plate extending in the front-rear direction, or in other words, a medium width direction, and a gear on the upper surface.

Between the rack teeth 16 and the guide groove 2, a guide shaft 17 serving as an example of a guide member is supported. The guide shaft 17 has a rod shape extending in the medium width direction.

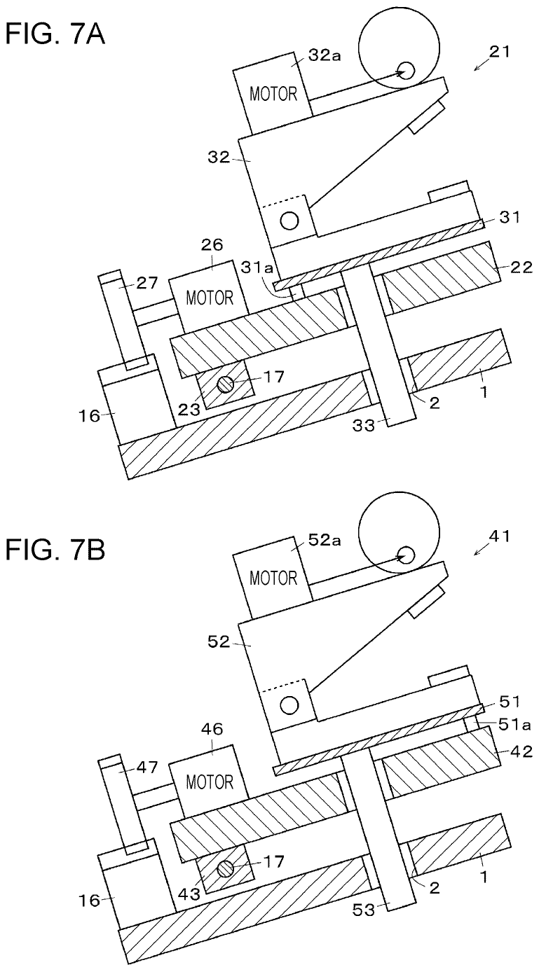

FIGS. 7A and 7B are diagrams of a staple unit according to the first example, where FIG. 7A is a diagram of a stapleless staple unit, and FIG. 7B is a diagram of a staple-using staple unit.

In FIG. 3, at an upper portion of the guide plate 1, a stapleless staple unit 21 serving as an example of a stapleless binding device and an example of a first unit is disposed.

In FIGS. 3 and 7A, the stapleless staple unit 21 includes a first cart portion 22 serving as an example of a first movement member. At the first cart portion 22, a first guided portion 23 serving as an example of a first guided member is disposed. The guide shaft 17 extends through the first guided portion 23. Thus, the first guided portion 23 is movable along the guide shaft 17, and the first cart portion 22 is movable along the guide shaft 17 in the front-rear direction, that is, the medium width direction.

At the left portion of the first cart portion 22, a first movement motor 26 serving as an example of a first driving source for movement is supported. A first driving gear 27 serving as an example of a gear to which a driving force is transmitted from the first movement motor 26 is engaged with the rack teeth 16. Thus, in accordance with forward rotation, reverse rotation, or stop of the first movement motor 26, the first cart portion 22 is capable of moving along the guide plate 1 in the front-rear direction, and stopping at a stapleless edge-binding position Pa1 or Pa2 or a stapleless corner binding position Pa3.

Components such as the rack teeth 16, the guide shaft 17, the first guided portion 23, and the first movement motor 26 form a first movement mechanism 16-26 according to the first example.

Above the first cart portion 22, a first turntable 31 serving as an example of a first inclination member is disposed. The first turntable 31 is supported to be rotatable about a first rotation shaft 31a with respect to the first cart portion 22. Above the first turntable 31, a stapleless stapler 32 serving as an example of a first binder is supported. The stapleless stapler 32 holds recording paper sheets S in accordance with the operation of a first operation motor 32a serving as an example of a first driving source for operation, and binds the bundle of the recording paper sheets S without using a staple. The method for binding the recording paper sheets S without staples may be any publicly known method, such as a method involving tearing part of paper sheets, pressing paper sheets in the thickness direction to entangle fibers, or deforming paper sheets.

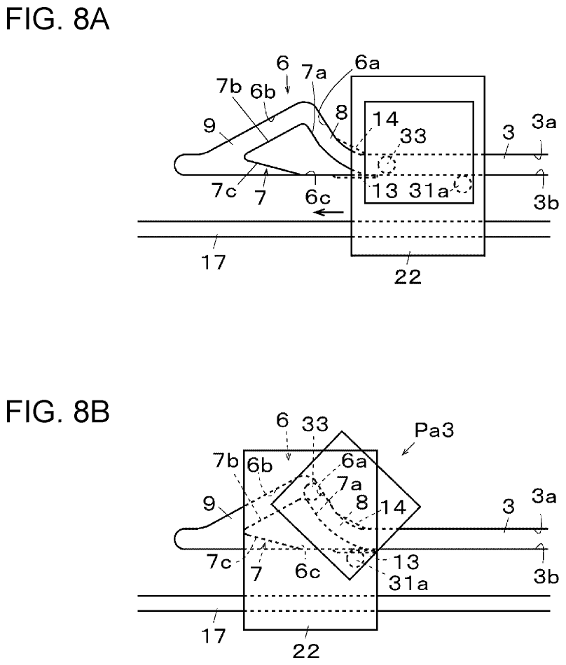

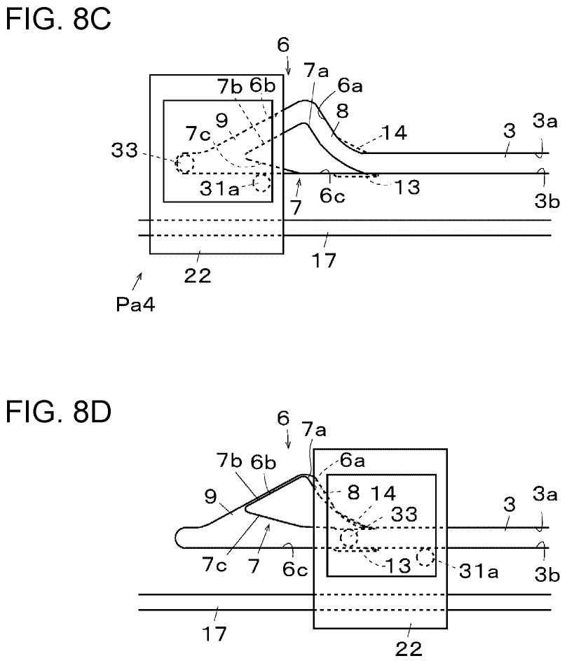

FIGS. 8A, 8B, 8C, and 8D are diagrams describing movement of the stapleless staple unit according to the first example, where FIG. 8A is a diagram of the stapleless staple unit that is moved to an edge-binding position, FIG. 8B is a diagram of the stapleless staple unit that is moved to a rear-corner-binding position, FIG. 8C is a diagram of the stapleless staple unit that is moved to a retraction position, and FIG. 8D is a diagram of the stapleless staple unit while the stapleless staple unit is being moved forward from the retraction position.

In FIGS. 7A and 7B and FIGS. 8A, 8B, 8C, and 8D, below the first turntable 31, a first inclined guide shaft 33 serving as an example of a first guided member is supported. The first inclined guide shaft 33 extends through the first cart portion 22, and is fitted to the guide groove 2.

In the first example, the stapleless staple unit 21 is entirely inclined downward to the lower left corresponding to the inclination of the guide plate 1.

In FIG. 8A, in the state where the first inclined guide shaft 33 is fitted to the edge-binding guide portion 3, the stapleless stapler 32 is in the state indicated by broken lines in FIG. 3, and is capable of binding the recording paper sheets S at a binding angle parallel to the edge of the recording paper sheets S.

In FIG. 8B, when the first inclined guide shaft 33 moves into the rear-corner-binding guide portion 8, the first inclined guide shaft 33 is guided along the rear-corner-binding guide portion 8, and the first turntable 31 and the stapleless stapler 32 rotate from the state illustrated in FIG. 8A to the state illustrated in FIG. 8B. Thus, the stapleless stapler 32 is capable of binding the recording paper sheets S at a binding angle inclined with respect to the edge of the recording paper sheets S.

In FIG. 8C, when the first cart portion 22 moves rearward from the state illustrated in FIG. 8B, the first inclined guide shaft 33 is guided by the retraction connection portion 9, and reaches the stapleless retraction position Pa4 at the rear end. Thus, as illustrated in FIG. 8C, the first turntable 31 and the stapleless stapler 32 rotate from the state illustrated in FIG. 8B to the state illustrated in FIG. 8C. In the first example, after finishing the binding process, the stapleless staple unit 21 is retracted to a stapleless retraction position Pa4 illustrated in FIG. 8C on standby.

In FIG. 8D, when the recording paper sheets S are delivered to the compile tray U4a, the stapleless staple unit 21 moves forward from the stapleless retraction position Pa4 illustrated in FIG. 8C. During this movement, the first inclined guide shaft 33 in the stapleless staple unit 21 comes into contact with the rear end of the third gate wall 7c of the switching gate 7. In accordance with the forward movement of the stapleless staple unit 21, the first inclined guide shaft 33 pushes the switching gate 7 away to move the switching gate 7 toward the third guide position. Thus, the stapleless staple unit 21 moves forward from the stapleless retraction position Pa4 while moving the switching gate 7 to the third guide position against an elastic force of the torsion spring 12.

After the stapleless staple unit 21 passes by the junction position P0, the switching gate 7 moves (returns) to the second guide position with the elastic force of the torsion spring 12. Thus, when the stapleless staple unit 21 moves rearward from the stapleless edge-binding position Pa1 or Pa2, the first inclined guide shaft 33 is guided by the rear-corner-binding guide portion 8 or the retraction connection portion 9.

In the first example, a width Lb of the retraction connection portion 9 is greater than a width La of the rear-corner-binding guide portion 8. When the width Lb of the retraction connection portion 9 is greater, the first inclined guide shaft 33 is less easily to get caught while moving from the rear-corner-binding guide portion 8 to the retraction connection portion 9, compared to when the width Lb of the retraction connection portion 9 is matched with the width La of the rear-corner-binding guide portion 8. More specifically, the stapleless staple unit 21 moves smoother. Particularly, when the width Lb of the retraction connection portion 9 is greater than or equal to 1.4 times (Lb=1.4×La) the width La of the rear-corner-binding guide portion 8, catches of the first inclined guide shaft 33 are effectively reduced.

Preferably, the surface at a boundary portion between the rear-corner-binding guide portion 8 and the retraction connection portion 9, which the first inclined guide shaft (an example of a guided member) 33 comes into contact when passing by, is to be chamfered. More specifically, the surface at a boundary portion 6a1 between the first protuberance right wall 6a and the second protuberance right wall 6b and the surface at a boundary portion 7a1 between the first gate wall 7a of the switching gate 7 and the second gate wall 7b are preferably chamfered to have a curved shape without having an acute shape.

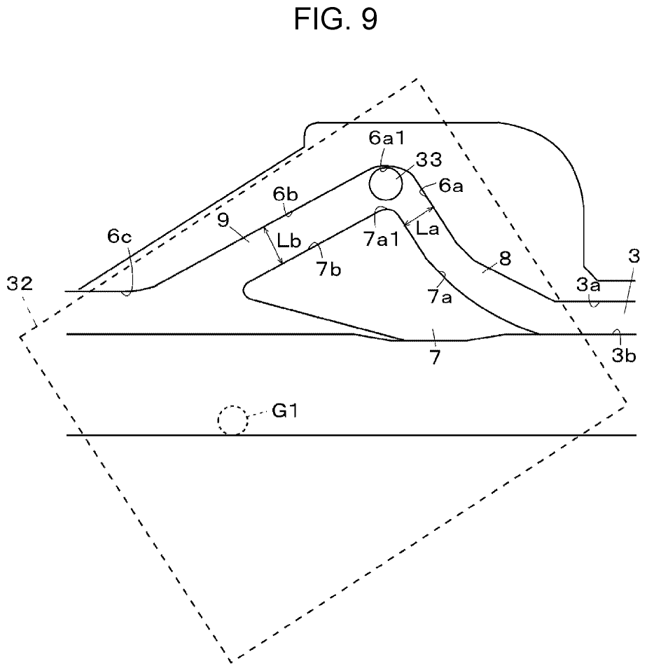

FIG. 9 is a diagram of the stapleless staple unit according to the first example, while the stapleless staple unit is being moved from the rear-corner-binding guide portion to a retraction connection portion.

In FIG. 9, the stapleless staple unit 21 according to the first example has a center of gravity G1 located below the first inclined guide shaft 33. The stapleless staple unit 21 according to the first example is entirely inclined to the lower left corresponding to the inclination of the guide plate 1. When moving through the rear-corner-binding guide portion 8 or the retraction connection portion 9, the stapleless staple unit 21 easily moves with its weight toward the first gate wall 7a or the second gate wall 7b located below in the gravitation direction, and is easily guided with the switching gate 7.

The guide plate 1 and the stapleless staple unit 21 according to the first example are entirely inclined to the lower left. When moving rearward, the stapleless staple unit 21 is guided upward in the gravitation direction at the rear-corner-binding guide portion 8, and when moving in the retraction connection portion 9, the stapleless staple unit 21 is guided downward in the gravitation direction. When the center of gravity of the stapleless staple unit 21 is located above the first inclined guide shaft 33, the first inclined guide shaft 33 is more likely to collide against the right walls 6a and 6b with the inertia while moving in the rear-corner-binding guide portion 8. However, the structure according to the first example reduces such a collision. Thus, the stapleless staple unit 21 is more likely to be smoothly guided from the rear-corner-binding guide portion 8 to the retraction connection portion 9.

In the first example, the center of gravity G1 of the stapleless staple unit 21 is set to facilitate guiding of the first inclined guide shaft 33 toward the gate wall 7a or 7b, but this is not the only possible example. For example, an urging member such as a spring or rubber to urge the stapleless staple unit 21 toward the gate wall 7a or 7b may be provided.

In FIG. 3, in front of the stapleless staple unit 21, a staple-using staple unit 41 serving as an example of a staple-using binding device and an example of a second unit is disposed.

In FIGS. 3 and 7B, the staple-using staple unit 41 according to the first example includes second cart portion 42, a second guided portion 43, a second movement motor 46 serving as an example of a second driving source for movement, a second driving gear 47, a second turntable 51, and a second inclined guide shaft 53, as in the first cart portion 22, the first guided portion 23, the first movement motor 26, the first driving gear 27, the first turntable 31, and the first inclined guide shaft 33 in the stapleless staple unit 21. Thus, in accordance with forward rotation, reverse rotation, or stop of the second movement motor 46, in the staple-using staple unit 41 according to the first example, the second cart portion 42 is capable of moving along the guide plate 1 in the front-rear direction, and stopping at a staple-using edge-binding position Pb1 or Pb2 or a staple-using corner binding position Pb3, serving as examples of staple-using binding positions.

In the first example, the staple-using edge-binding positions Pb1 and Pb2 are set at the same positions as the stapleless edge-binding positions Pa1 and Pa2. Alternatively, the staple-using edge-binding positions Pb1 and Pb2 and the stapleless edge-binding positions Pa1 and Pa2 may be set at different positions in the sheet width direction, instead of the same positions.

Preferably, the second movement motor 46 according to the first example has the same motor capacity as the first movement motor 26 to standardize components and reduce manufacturing costs. Generally, the first operation motor 32a of the stapleless stapler 32 is a motor with a greater capacity than the operation motor (second operation motor 52a) of the staple-using staple unit 41. Thus, the stapleless staple unit 21 is more likely to have a greater total weight than the staple-using staple unit 41. In correspondence with this, the first movement motor 26 may be a motor with a greater capacity than the second movement motor 46.

In place of the stapleless stapler 32 of the stapleless staple unit 21, the staple-using staple unit 41 according to the first example includes a staple-using stapler 52 serving as a second binder. The staple-using stapler 52 drives a staple into the recording paper sheets S to bind the recording paper sheets S in accordance with the operation of the second operation motor 52a serving as an example of a second driving source for operation. Thus, the staple-using staple unit 41 according to the first example is capable of performing postprocessing different from postprocessing performed by the stapleless staple unit 21.

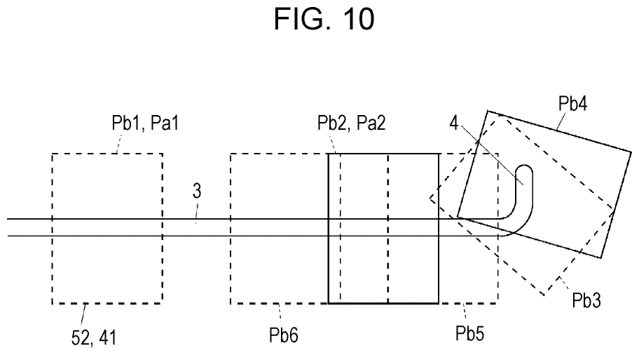

FIG. 10 is a diagram describing movement of the staple-using staple unit according to the first example.

In FIG. 3, in the state where the second inclined guide shaft 53 serving as an example of a guided member is fitted to the edge-binding guide portion 3, the staple-using stapler 52 is capable of binding the recording paper sheets S at a binding angle parallel with the edge of the recording paper sheets S as indicated with broken lines at the staple-using edge-binding position Pb1 or Pb2 in FIG. 3.

When the second inclined guide shaft 53 moves into the front-corner binding guide portion 4, the second inclined guide shaft 53 is guided along the front-corner binding guide portion 4, and the second turntable 51 and the staple-using stapler 52 rotate from the state indicated with broken lines in FIG. 3 to the state indicated with solid lines in FIG. 3. Thus, the staple-using stapler 52 is capable of binding the recording paper sheets S at a binding angle inclined with respect to the edge of the recording paper sheets S at the staple-using corner binding position Pb3 illustrated in FIGS. 3 and 10.

In FIG. 10, in the first example, after finishing the binding process, the staple-using staple unit 41 is retracted to a staple-using retraction position Pb4 in front of the staple-using corner binding position Pb3 on standby. The staple-using corner binding position Pb3 may be also used as the staple-using retraction position of the staple-using staple unit 41 for common use.

In the first example, the staple-using staple unit 41 is replenished with staples at the staple-using retraction position Pb4. More specifically, at the staple-using retraction position Pb4, a front door of the finisher U4, not illustrated, is opened for staple replenishment. Thus, the staple-using retraction position Pb4 is also used as a staple replenishment position for common use. In the first example, the staple-using retraction position Pb4 and the staple replenishment position are at the same position, but this is not the only possible example. The staple-using retraction position Pb4 and the staple replenishment position may be at different positions. Alternatively, the staple-using corner binding position Pb3 and the staple-using retraction position Pb4 may be at the same position, and only the staple replenishment position may be located at a different position. Alternatively, the staple-using corner binding position Pb3 and the staple replenishment position may be at the same position, and only the staple-using retraction position Pb4 may be located at a different position. In this manner, the positions may be determined in any manner.

In the first example, the stapleless staple unit 21 and the staple-using staple unit 41 share the same guide groove 2, and retract into separate positions at the rear side and the near side, respectively. When the two retraction positions of the stapleless staple unit 21 and the staple-using staple unit 41 are located on the same side (for example, rear side), the space is to be retained to arrange the two retraction positions without overlapping each other, as in the structure described in Japanese Unexamined Patent Application Publication No. 2024-15984, or the guide grooves connected to the retraction positions are to be elongated. Thus, the entire device is more likely to have a larger size. In contrast, in the first example, the size increase of the entire device is at least partially prevented compared to the structure where the retraction positions are provided on the same side.

### Description of Control Member According to First Example

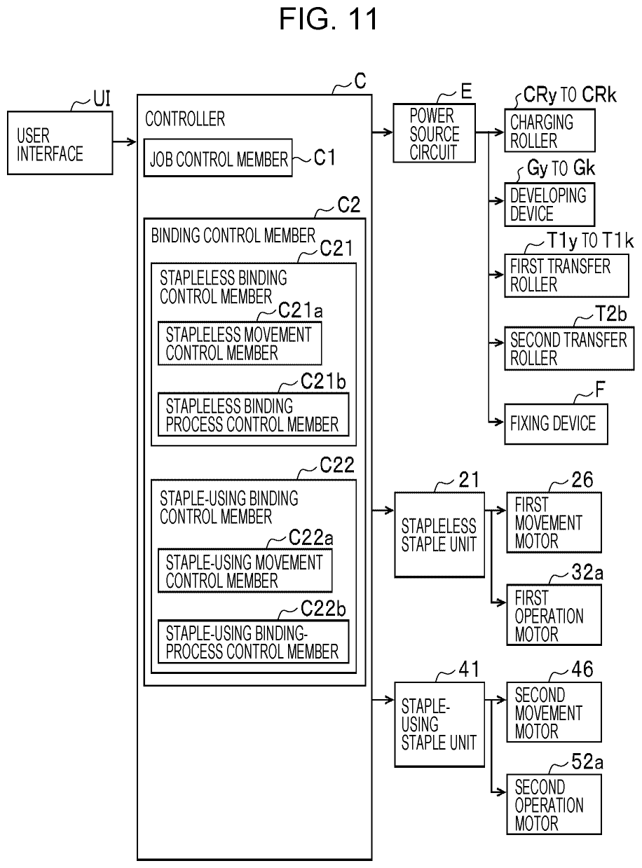

FIG. 11 is a functional block diagram of a control portion according to the first example.

In FIG. 11, the controller C in the copying machine U includes an input-output interface I/O for, for example, inputs or outputs of signals from or to the external devices. The controller C includes a read only memory ROM that stores, for example, programs and information for performing intended processes. The controller C further includes a random access memory RAM that temporarily stores intended data. The controller C further includes a central processing unit CPU that performs processes in accordance with the programs stored in, for example, the ROM. The controller C according to the first example is thus formed by a small-sized information processing device, that is, a microcomputer. The controller C is thus capable of implementing various functions by executing the programs stored in, for example, the ROM.

The controller C according to the first example receives inputs of signals from a signal output element, and outputs signals to a controllable element for controlling.

### Description of Signal Output Element

The controller C receives inputs of signals from a user interface UI or other signal output elements including sensors not illustrated.

The user interface UI inputs the inputs from a user or an operator into the controller C.

### Description of Controllable Element

The controller C outputs signals to the power source circuit E, the first movement motor 26, the first operation motor 32a, the second movement motor 46, the second operation motor 52a, or other controllable elements not illustrated.

The power source circuit E controls, for example, charging bias to the charging rollers CRy to CRk, development bias to the developing devices Gy to Gk, first transfer bias to the first transfer rollers T1y to T1k, second transfer bias to the second transfer roller T2b, or power supply to the heater in the fixing device F.

The first movement motor 26 moves the stapleless staple unit 21 in the front-rear direction.

The first operation motor 32a operates the stapleless stapler 32 to perform stapleless binding.

The second movement motor 46 moves the staple-using staple unit 41 in the front-rear direction.

The second operation motor 52a operates the staple-using stapler 52 to perform staple-using binding.

### Functions of Controller C

The controller C according to the first example has functional members (functional modules or program modules) described below.

A job control member C1 controls a job serving as an image forming operation. When a job is started, the job control member C1 controls components such as the photoconductors PRy to PRk or the power source circuit E to form an image on a recording paper sheet S.

A binding controller C2 includes a stapleless binding control member C21 and a staple-using binding control member C22. The binding controller C2 controls the stapleless staple unit 21 and the staple-using staple unit 41 to control the binding process.

The stapleless binding control member C21 includes a stapleless movement control member C21a and a stapleless binding process control member C21b. The stapleless binding control member C21 controls the stapleless staple unit 21 to control the stapleless binding process.

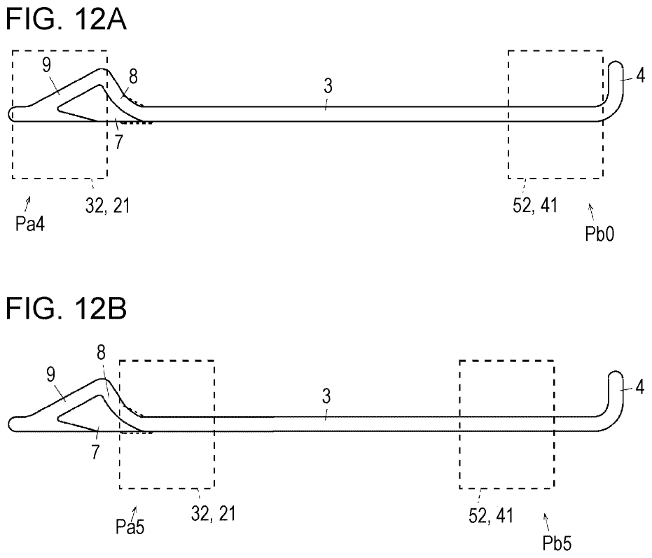

FIGS. 12A and 12B are diagrams of positions of binding devices according to the first example, where FIG. 12A is a diagram of the binding devices in non-operational positions, and FIG. 12B is a diagram of the binding devices in positions to perform an aligning process.

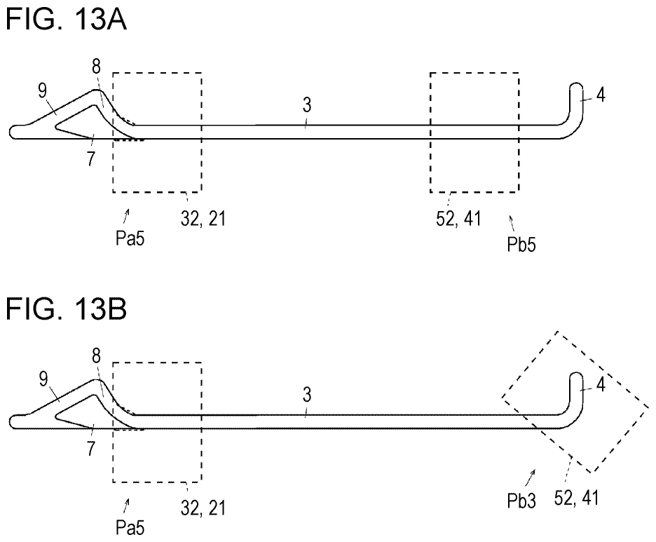

FIGS. 13A and 13B are diagrams describing positions of the binding devices according to the first example to perform staple-using corner binding, where FIG. 13A is a diagram of the binding devices in positions for sheet delivery, and FIG. 13B is a diagram of the binding devices that are moved to staple-using corner binding positions.

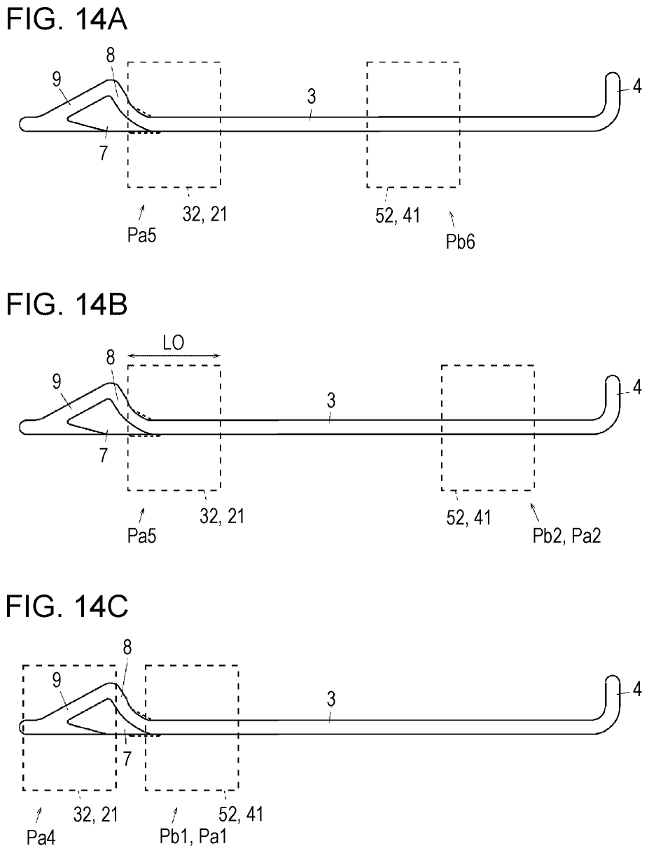

FIGS. 14A, 14B, and 14C are diagrams describing positions of the binding devices according to the first example to perform staple-using edge binding, where FIG. 14A is a diagram of the binding devices in positions for sheet delivery, FIG. 14B is a diagram of the binding devices during a first shot in staple-using edge binding, and FIG. 14C is a diagram of the binding devices during a second shot in staple-using edge binding.

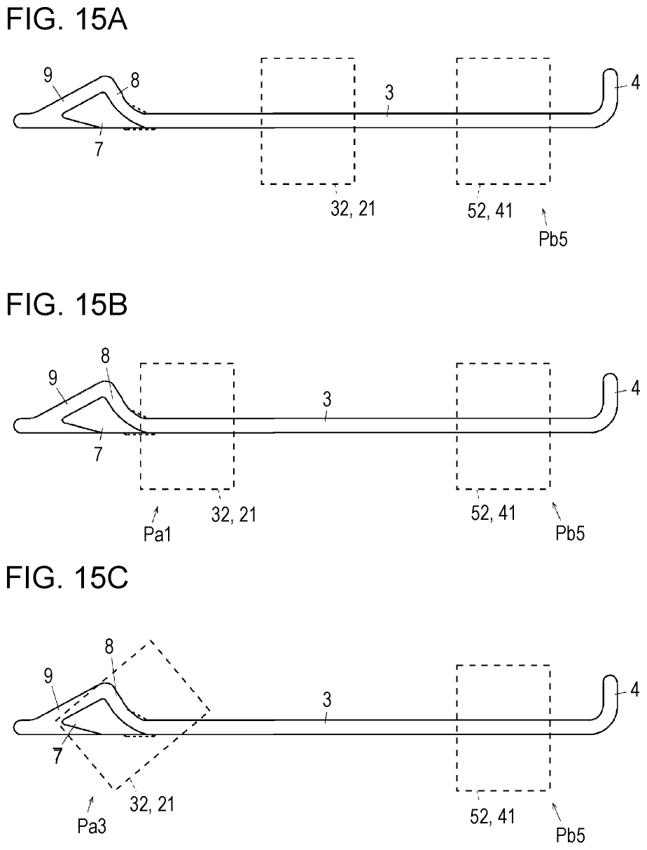

FIGS. 15A, 15B, and 15C are diagrams of positions of the binding devices according to the first example to perform stapleless corner binding, where FIG. 15A is a diagram of the binding devices that have passed a switching member before sheet delivery, FIG. 15B is a diagram of the binding devices in positions for sheet delivery, and FIG. 15C is a diagram of the binding devices after the binding devices are moved to stapleless corner binding positions.

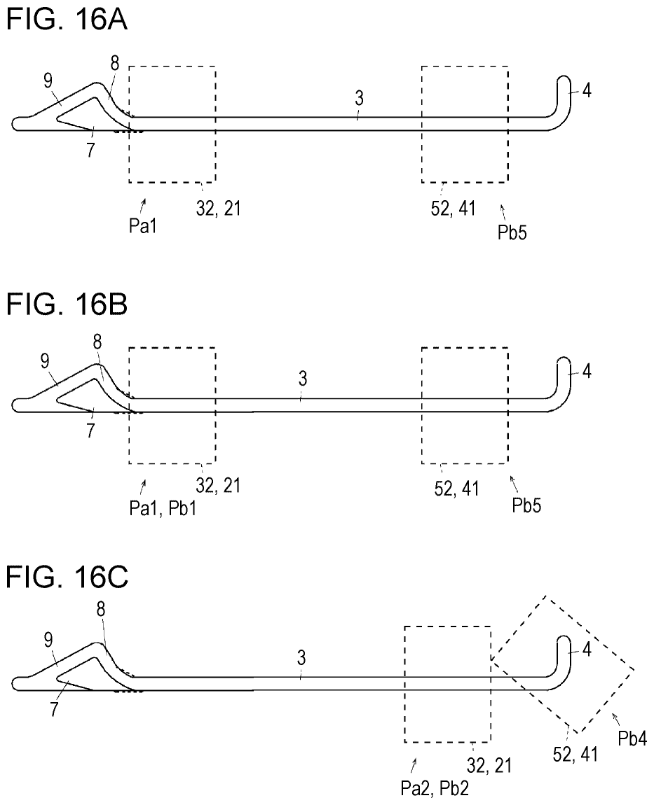

FIGS. 16A, 16B, and 16C are diagrams of positions of the binding devices according to the first example to perform stapleless edge binding, where FIG. 16A is a diagram of the binding devices in positions for sheet delivery, FIG. 16B is a diagram of the binding devices during a first shot in stapleless edge binding, and FIG. 16C is a diagram of the binding devices during a second shot in stapleless edge binding.

The stapleless movement control member C21a controls movement of the stapleless staple unit 21 using the first movement motor 26.

In FIG. 12A, the stapleless movement control member C21a according to the first example moves the stapleless staple unit 21 to the stapleless retraction position Pa4 in the state where postprocessing is not performed.

In FIG. 12B, the recording paper sheets S are delivered to the compile tray U4a. To perform an aligning process (unstapling process) in which a bundle of the recording paper sheets S is discharged while being aligned without being bound, the stapleless movement control member C21a according to the first example moves the stapleless staple unit 21 to a stapleless standby position Pa5. Thus, the stapleless staple unit 21 stops at the stapleless standby position Pa5 on standby. In this state, when the recording paper sheets S are delivered to the compile tray U4a, the leading edge portions of the recording paper sheets S move into the stapleless stapler 32 on standby. Thus, the stapleless stapler 32 holds the leading edge portions of the delivered recording paper sheets S not to allow the leading edge portions to turn up or down. Thus, regardless of when an aligner of the compile tray U4a, or a so-called end wall has a short length, the recording paper sheets S are held by the aligner and the stapleless stapler 32 not to be turned. When the aligning process is finished, the stapleless movement control member C21a moves the stapleless staple unit 21 to the stapleless retraction position Pa4.

To perform the staple-using corner binding, the stapleless movement control member C21a according to the first example moves the stapleless staple unit 21 to the stapleless standby position Pa5 as illustrated in FIG. 13A. After the delivery of the recording paper sheets S is finished, the stapleless staple unit 21 is held at the stapleless standby position Pa5 as illustrated in FIG. 13B. When the staple-using staple unit 41 finishes the staple-using corner binding, the stapleless movement control member C21a moves the stapleless staple unit 21 to the stapleless retraction position Pa4 illustrated in FIG. 12A.

To perform staple-using edge binding, the stapleless movement control member C21a according to the first example moves the stapleless staple unit 21 to the stapleless standby position Pa5 as illustrated in FIG. 14A. After the delivery of the recording paper sheets S is finished, as illustrated in FIG. 14B, the stapleless staple unit 21 is held at the stapleless standby position Pa5 until the staple-using staple unit 41 finishes a first shot in the staple-using binding process. When the staple-using staple unit 41 is moved from the staple-using edge-binding position Pb2 for the first shot to the staple-using edge-binding position Pb1 for the second shot, the stapleless movement control member C21a moves the stapleless staple unit 21 to the stapleless retraction position Pa4 as illustrated in FIG. 14C.

The period when the staple-using staple unit 41 is moved from the staple-using edge-binding position Pb2 for the first shot to the staple-using edge-binding position Pb1 for the second shot overlaps the period when the stapleless staple unit 21 is moved. When the staple-using staple unit 41 starts being moved after the stapleless staple unit 21 finishes its movement, time taken to finish the entire process is longer. However, when the movement periods overlap, time taken to finish the movements is shorter.

Preferably, the stapleless movement control member C21a according to the first example controls the stapleless staple unit 21 and the staple-using staple unit 41 to move the stapleless staple unit 21 at a lower speed than the staple-using staple unit 41. More specifically, preferably, the stapleless movement control member C21a controls the first movement motor 26 to move the stapleless staple unit 21 at a lower moving speed. When both of the units 21 and 41 are moved, vibrations occur, and the vibrations are more likely to be stronger as the speed at which the units 21 and 41 move is higher. When the movement periods of the two units 21 and 41 overlap, vibrations are more likely to be stronger than when the movement periods do not overlap. In contrast, when the movement periods of the two units 21 and 41 overlap and the stapleless staple unit 21 with a higher weight moves at a lower speed, the vibrations of the finisher U4 are further reduced compared to the case where the two units 21 and 41 are moved at the same speed.

The units 21 and 41 are to move at different speeds not to cause the staple-using staple unit 41 moving at a high speed to collide with the stapleless staple unit 21 moving at a low speed from behind.

Preferably, the distance between the stapleless standby position Pa5 and the stapleless retraction position Pa4 is shorter than a distance Lc between the staple-using edge-binding position Pb2 for the first shot where the staple-using staple unit 41 performs a first shot of binding and the staple-using edge-binding position Pb1 for the second shot where the staple-using staple unit 41 performs a second shot of binding. This structure less easily allows the staple-using staple unit 41 moving at a high speed to collide with the stapleless staple unit 21 moving at a low speed from behind. More specifically, preferably, moving speeds Va and Vb are set to satisfy at least ta<tb, where ta (=L0/Va) is time taken for the stapleless staple unit 21 to move from the stapleless standby position Pa5, adjacent to the staple-using edge-binding position Pb1 for the second shot, by a width L0 of the stapleless staple unit 21 at the moving speed Va, and tb (=Lc/Vb) is time taken for the staple-using staple unit 41 to move a distance Lc between the staple-using edge-binding positions Pb1 and Pb2 at the moving speed Vb.

In the first example, the stapleless staple unit 21 and the staple-using staple unit 41 start moving at the same timing.

Alternatively, the stapleless staple unit 21 and the staple-using staple unit 41 may start moving at different timings. When the stapleless staple unit 21 and the staple-using staple unit 41 start being moved at the same timing, vibrations may be amplified or inrush currents into the motors 26 and 46 may overlap, resulting in a heavy electrical load.

The units 21 and 41 finish being moved when arriving at intended positions. The moving speeds Va and Vb may be set to intentionally cause the units 21 and 41 to finish moving at the same time. Conversely, the moving speeds Va and Vb may be set to intentionally cause the units 21 and 41 to finish moving at different times.

To perform stapleless corner binding, as illustrated in FIG. 15A, the stapleless movement control member C21a according to the first example causes the stapleless staple unit 21 to pass through the switching gate 7 once to move the stapleless staple unit 21 forward beyond the junction position P0. The stapleless movement control member C21a then moves the stapleless staple unit 21 rearward to the stapleless edge-binding position Pa1 illustrated in FIG. 15B. In the first example, the stapleless edge-binding position Pa1 is a standby position for the stapleless staple unit 21 during sheet delivery. In other words, the stapleless edge-binding position Pa1 is the same as the second stapleless standby position. The second stapleless standby position (stapleless edge-binding position Pa1) is located in front of the stapleless standby position Pa5, but is adjacent to or almost the same position as the stapleless standby position Pa5. The second stapleless standby position (stapleless edge-binding position Pa1) and the stapleless standby position Pa5 may be set at the same position.

The recording paper sheets S are delivered to the compile tray U4a while the stapleless staple unit 21 is moved to the second stapleless standby position (stapleless edge-binding position Pa1).

After the delivery of the recording paper sheets S is finished, the stapleless movement control member C21a moves the stapleless staple unit 21 to the stapleless corner binding position Pa3 illustrated in FIG. 15C. After the stapleless corner binding process is finished, the stapleless movement control member C21a moves the stapleless staple unit 21 to the stapleless retraction position Pa4.

To perform stapleless edge binding, the stapleless movement control member C21a according to the first example causes the stapleless staple unit 21 to pass by the junction position P0 once as illustrated in FIG. 15A, and then moves the stapleless staple unit 21 to the stapleless edge-binding position Pa1 illustrated in FIG. 16A, that is, to the second stapleless standby position. After the delivery of the recording paper sheets S is finished, as illustrated in FIG. 16B, a first shot in the stapleless edge-binding process is performed at the stapleless edge-binding position Pa1. After the first shot in the stapleless edge-binding process is finished, the stapleless movement control member C21a moves the stapleless staple unit 21 to the stapleless edge-binding position Pa2 for the second shot as illustrated in FIG. 16C. After the second shot in the stapleless edge-binding process is finished, the stapleless movement control member C21a moves the stapleless staple unit 21 to the stapleless retraction position Pa4.

The period when the stapleless staple unit 21 is moved from the stapleless edge-binding position Pa1 for the first shot to the stapleless edge-binding position Pa2 for the second shot overlaps the movement period of the staple-using staple unit 41. When the stapleless staple unit 21 starts being moved after the staple-using staple unit 41 finishes its movement, time taken to finish the entire process is longer. However, when the movement periods overlap, time taken to finish the movements is shorter.

As in the case illustrated in FIGS. 14A to 14C, the stapleless movement control member C21a according to the first example controls the stapleless staple unit 21 and the staple-using staple unit 41 to move the stapleless staple unit 21 at a lower speed than the staple-using staple unit 41 also when moving the stapleless staple unit 21 from the stapleless edge-binding position Pa1 for the first shot to the stapleless edge-binding position Pa2 for the second shot.

The units 21 and 41 start being moved at the same timing. The following stapleless staple unit 21 moves at a lower speed, and is thus prevented from colliding with the preceding staple-using staple unit 41 from behind. When the units 21 and 41 are to start being moved at different timings, the movement start timings of the units 21 and 41 are set not to allow the stapleless staple unit 21 to collide with the preceding staple-using staple unit 41.

When moving the stapleless staple unit 21 toward the stapleless retraction position Pa4, the stapleless movement control member C21a according to the first example moves the stapleless staple unit 21 at a lower speed than the moving speed in the edge-binding guide portion 3.

In the first example, while the stapleless staple unit 21 is being moved toward the stapleless retraction position Pa4, the stapleless staple unit 21 moves through the rear-corner-binding guide portion 8 and the retraction connection portion 9, which are bent paths. Thus, when the stapleless staple unit 21 moves to the stapleless retraction position Pa4 at the same moving speed as when moving in the edge-binding guide portion 3, more specifically, at a constant speed, the inertia caused while moving through the rear-corner-binding guide portion 8 is more likely to cause the first inclined guide shaft 33 to collide with the right walls 6a and 6b. More specifically, at the collision, the first inclined guide shaft 33 may get caught in a boundary portion between the rear-corner-binding guide portion 8 and the retraction connection portion 9 to cause a movement failure, to cause a crashing sound, an unusual sound, or vibrations, or to damage components. Particularly, as in the first example, when an angle formed by the rear-corner-binding guide portion 8 and the retraction connection portion 9 is an acute angle, the first inclined guide shaft 33 is more likely to get caught or collide with the right walls 6a and 6b. In contrast, in the first example, the first inclined guide shaft 33 is controlled to move to the stapleless retraction position Pa4 at a lower speed, and thus causes fewer movement failures compared to when moving at a constant speed.

The first inclined guide shaft 33 may move at a low speed throughout the rear-corner-binding guide portion 8 and the retraction connection portion 9, but this is not the only possible example. For example, at timing when the first inclined guide shaft 33 transfers from the rear-corner-binding guide portion 8 to the retraction connection portion 9, in other words, when the first inclined guide shaft 33 is to reach the boundary portion between the rear-corner-binding guide portion 8 and the retraction connection portion 9, the first inclined guide shaft 33 may move at a low speed, whereas in other portions, may move at the same speed as when moving in the edge-binding guide portion 3. More specifically, the first inclined guide shaft 33 may move at a low speed only in a specific timing during movement to the stapleless retraction position Pa4. In this case, the low-speed period is shorter compared to the case where the first inclined guide shaft 33 moves at a low speed throughout the movement.

When the stapleless staple unit 21 is controlled to move at a low speed, instead of being decelerated, the stapleless staple unit 21 may be temporarily stopped, in other words, may temporarily move at a speed of zero. When the stapleless staple unit 21 is temporarily stopped, the first inclined guide shaft 33 is less likely to get caught or collide with the right walls 6a and 6b with inertia, and the stapleless staple unit 21 moves smoothly toward the gate wall 7a or 7b with its weight during temporary stop, and thus is less likely to get caught.

The stapleless binding process control member C21b controls the first operation motor 32a to perform stapleless binding with the stapleless stapler 32. The stapleless binding process control member C21b performs a stapleless edge-binding process after delivery of the recording paper sheets S while the stapleless staple unit 21 is moved to the stapleless edge-binding position Pa1 or Pa2. The stapleless binding process control member C21b performs a stapleless corner binding process while the stapleless staple unit 21 is moved to the stapleless corner binding position Pa3.

The staple-using binding control member C22 includes a staple-using movement control member C22a and a staple-using binding-process control member C22b. The staple-using binding control member C22 controls the staple-using staple unit 41 to control the staple-using binding process.

The staple-using movement control member C22a controls movement of the staple-using staple unit 41 with the second movement motor 46.

In FIG. 12A, when postprocessing is not performed, the staple-using movement control member C22a according to the first example moves the staple-using staple unit 41 to the initial position Pb0 on standby.

In FIG. 12B, when the aligning process is to be performed, the staple-using movement control member C22a moves the staple-using staple unit 41 to the staple-using standby position Pb5 on standby. Thus, as in the case of the stapleless staple unit 21, the staple-using binding control member C22 holds the delivered leading edge portions of the recording paper sheets S not to allow the leading edge portions to turn up or down. In the first example, the staple-using standby position Pb5 is located in front of the second staple-using edge-binding position Pb2, but is adjacent to or almost the same position as the second staple-using edge-binding position Pb2. The staple-using edge-binding position Pb2 for the first shot and the staple-using standby position Pb5 may be set at the same position. After the aligning process is finished, the staple-using movement control member C22a moves the staple-using staple unit 41 to the initial position Pb0.

When the staple-using corner binding is to be performed, the staple-using movement control member C22a moves the staple-using staple unit 41 to the staple-using standby position Pb5 as illustrated in FIG. 13A. After the delivery of the recording paper sheets S is finished, the staple-using staple unit 41 is moved to the staple-using corner binding position Pb3 illustrated in FIG. 13B. After the staple-using staple unit 41 finishes the staple-using corner binding, the staple-using movement control member C22a moves the staple-using staple unit 41 to the initial position Pb0 illustrated in FIG. 12A.

When the staple-using edge binding is to be performed, the staple-using movement control member C22a moves the staple-using staple unit 41 to the second staple-using standby position Pb6 as illustrated in FIG. 14A. The second staple-using standby position Pb6 is set at a position different from the staple-using standby position Pb5, but may be set at the same position. After the delivery of the recording paper sheets S is finished, the staple-using movement control member C22a moves the staple-using staple unit 41 to the staple-using edge-binding position Pb2 for the first shot illustrated in FIG. 14B. After the staple-using staple unit 41 finishes the first shot in the staple-using binding process, the staple-using movement control member C22a moves the staple-using staple unit 41 to the staple-using edge-binding position Pb1 for the second shot illustrated in FIG. 14C.

At this time, as described above, the staple-using movement control member C22a moves the staple-using staple unit 41 at a moving speed Vb higher than the moving speed Va of the stapleless staple unit 21.

The staple-using movement control member C22a moves the staple-using staple unit 41 to overlap the movement period of the stapleless staple unit 21 and the movement period of the staple-using staple unit 41 with each other.

When the binding process at the staple-using edge-binding position Pb1 for the second shot is finished, the staple-using movement control member C22a moves the staple-using staple unit 41 to the initial position Pb0 illustrated in FIG. 12A.

When the stapleless corner binding is to be performed, the staple-using movement control member C22a moves the staple-using staple unit 41 to the staple-using standby position Pb5 illustrated in FIG. 15B.

In FIGS. 15B and 15C, the staple-using movement control member C22a holds the staple-using staple unit 41 at the staple-using standby position Pb5 until the delivery of the recording paper sheets S is finished and the stapleless staple unit 21 finishes the stapleless corner binding process. After the stapleless corner binding process is finished, the staple-using movement control member C22a moves the staple-using staple unit 41 to the initial position Pb0 illustrated in FIG. 12A.

When the stapleless edge binding is to be performed, the staple-using movement control member C22a moves the staple-using staple unit 41 to the staple-using standby position Pb5 illustrated in FIG. 16A. After the delivery of the recording paper sheets S is finished, as illustrated in FIG. 16B, the staple-using movement control member C22a holds the staple-using staple unit 41 at the staple-using standby position Pb5 until the first shot in the stapleless binding process is finished. After the first shot in the stapleless edge-binding process is finished, the staple-using movement control member C22a moves the staple-using staple unit 41 to the staple-using retraction position Pb4 as illustrated in FIG. 16C.

The period when the staple-using staple unit 41 moves to the staple-using retraction position Pb4 overlaps the period when the stapleless staple unit 21 moves from the stapleless edge-binding position Pa1 for the first shot to the stapleless edge-binding position Pa2 for the second shot. When the stapleless staple unit 21 starts being moved after the staple-using staple unit 41 finishes its movement, time taken to finish the entire process is longer. However, when the movement periods overlap, time taken to finish the movements is shorter.

As described above, when moving the stapleless staple unit 21 between the stapleless edge-binding positions Pa1 and Pa2, the staple-using movement control member C22a moves the staple-using staple unit 41 at the moving speed Vb higher than the moving speed Va of the stapleless staple unit 21.

The staple-using movement control member C22a moves the staple-using staple unit 41 to overlap the movement period of the stapleless staple unit 21 and the movement period of the staple-using staple unit 41.

After the binding process is finished at the stapleless edge-binding position Pa2 for the second shot, the staple-using movement control member C22a moves the staple-using staple unit 41 to the initial position Pb0 illustrated in FIG. 12A.

The staple-using binding-process control member C22b controls the second operation motor 52a to perform staple-using binding with the staple-using stapler 52. The staple-using binding-process control member C22b performs a staple-using edge-binding process after the delivery of the recording paper sheets S while the staple-using staple unit 41 is moved to the staple-using edge-binding position Pb1 or Pb2. The staple-using binding-process control member C22b performs a staple-using corner binding process while the staple-using staple unit 41 is moved to the staple-using corner binding position Pb3.

### Modification Examples

Although an exemplary embodiment of the present disclosure has been described in detail above, the present disclosure is not limited to the above example, and may be modified in various manners within the scope of the gist of the present disclosure described in the scope of claims. Modification examples (H01) to (H05) of the present disclosure are described below.

(H01) As the image forming apparatus according to the above example, a copying machine U has been described, but the present disclosure is not limited to this. For example, the image forming apparatus may be formed from a printer, a fax machine, or a multifunction machine having multiple or all the functions of these. Instead of an electrophotographic image forming apparatus, the image forming apparatus is applicable to any image forming apparatus such as an inkjet or thermal transfer image forming apparatus.

(H02) The apparatus according to the above example employing four-color developers is described as an example of the copying machine U, but the present disclosure is not limited to this. For example, the copying machine U is also applicable to a single-color image forming apparatus or a multi-color image forming apparatus using three or less colors or five or more colors.

(H03) In the above example, the endless intermediate transfer belt B is described as an example of an image carrier, but the present disclosure is not limited to this. For example, the image carrier may be a cylindrical intermediate transfer drum, a photoconductor drum, or a photoconductor belt. Alternatively, the present disclosure is also applicable to a structure that includes no intermediate transfer body and that directly records an image from a photoconductor to a recording paper sheet S.

(H04) In the above example, a structure including the stapleless staple unit 21 and the staple-using staple unit 41 is described as an example of a unit that performs postprocessing, but the present disclosure is not limited to this. For example, the present disclosure is also applicable to a structure including only a single staple unit on the guide plate 1. The present disclosure is also applicable to a structure including three or more staple units. Instead of a staple unit, the present disclosure is also applicable to, for example, a punching unit that forms punch holes, a unit that forms folds, or a unit that forms perforations.

(H05) In the above example, the finisher U4 is disposed at the lower paper exit tray TRh, but the present disclosure is not limited to this. The finisher U4 may be a postprocessing device externally attached to the side portion of the copying machine U.

(H06) In the above example, the turntable 31 or 51 is rotationally movable with respect to the corresponding cart portion 22 or 42, but the present disclosure is not limited to this. For example, the turntable 31 or 51 may have any structure, for example, may be slidably moved with respect to the cart portion 22 or 42 or rotationally and slidably moved with respect to the cart portion 22 or 42.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A postprocessing device comprising:
a binder that binds media;
a guided member disposed at the binder;
a guide member that guides the guided member disposed at the binder, the guide member including a first guide portion that extends in a width direction of the media, a second guide portion that is connected to the first guide portion and extends in a direction inclined with respect to the width direction, and a third guide portion that is connected to the second guide portion and extends in a direction inclined with respect to the direction in which the second guide portion extends; and
a control member that controls movement of the binder along the guide member, and controls the binder to move the guided member in the second guide portion and the third guide portion at a lower speed than when moving the guided member in the first guide portion.
   (((2)))

The postprocessing device according to (((1))),
wherein the second guide portion and the third guide portion each have a width that crosses a direction in which the guided member passes, and the width of third guide portion is greater than the width of the second guide portion.
   (((3)))

The postprocessing device according to (((2))),
wherein the width of the third guide portion is greater than or equal to 1.4 times the width of the second guide portion.
   (((4)))

The postprocessing device according to (((2))) or (((3))),
wherein at a boundary portion between the second guide portion and the third guide portion, a surface with which the guided member comes into contact while passing thereby is chamfered.
   (((5)))

The postprocessing device according to any one of (((1))) to (((4))),
wherein, at a timing when moving the binder from the second guide portion and the third guide portion, the control member moves the binder at a low speed.
   (((6)))

The postprocessing device according to any one of (((1))) to (((5))),
wherein the control of the control member to move the binder at a low speed includes a temporary stop of the binder.
   (((7)))

The postprocessing device according to any one of (((1))) to (((6))),
wherein the guide member moves the binder upward in a gravitation direction when guiding the guided member in the second guide portion toward the third guide portion.
   (((8)))

The postprocessing device according to (((7))),
wherein while the guided member is being guided in the second guide portion, a center o gravity of the binder is located below the guided member.
   (((9)))

The postprocessing device according to (((7))) or (((8))), comprising:
an urging member that urges the binder downward in the gravitation direction.
   (((10)))

An image forming apparatus, comprising:
a recording member that records images on media; and
the postprocessing device according to any one of (((1))) to (((9))) that performs postprocessing on media discharged from the recording member.

What is claimed is:

1. A postprocessing device comprising:
a binder that binds media;
a guided member disposed at the binder;
a guide member that guides the guided member disposed at the binder, the guide member including a first guide portion that extends in a width direction of the media, a second guide portion that is connected to the first guide portion and extends in a direction inclined with respect to the width direction, and a third guide portion that is connected to the second guide portion and extends in a direction inclined with respect to the direction in which the second guide portion extends; and
a control member that controls movement of the binder along the guide member, and controls the binder to move the guided member in the second guide portion and the third guide portion at a lower speed than when moving the guided member in the first guide portion.

2. The postprocessing device according to claim 1,
wherein the second guide portion and the third guide portion each have a width that crosses a direction in which the guided member passes, and the width of third guide portion is greater than the width of the second guide portion.

3. The postprocessing device according to claim 2,
wherein the width of the third guide portion is greater than or equal to 1.4 times the width of the second guide portion.

4. The postprocessing device according to claim 2,
wherein at a boundary portion between the second guide portion and the third guide portion, a surface with which the guided member comes into contact while passing thereby is chamfered.

5. The postprocessing device according to claim 1,
wherein, at a timing when moving the binder from the second guide portion and the third guide portion, the control member moves the binder at a low speed.

6. The postprocessing device according to claim 1,
wherein the control of the control member to move the binder at a low speed includes a temporary stop of the binder.

7. The postprocessing device according to claim 1,
wherein the guide member moves the binder upward in a gravitation direction when guiding the guided member in the second guide portion toward the third guide portion.

8. The postprocessing device according to claim 7,
wherein while the guided member is being guided in the second guide portion, a center o gravity of the binder is located below the guided member.

9. The postprocessing device according to claim 7, comprising:
an urging member that urges the binder downward in the gravitation direction.

10. An image forming apparatus, comprising:
a recording member that records images on media; and
the postprocessing device according to claim 1 that performs postprocessing on media discharged from the recording member.

11. An image forming apparatus, comprising:
a recording member that records images on media; and
the postprocessing device according to claim 2 that performs postprocessing on media discharged from the recording member.

12. An image forming apparatus, comprising:
a recording member that records images on media; and
the postprocessing device according to claim 3 that performs postprocessing on media discharged from the recording member.

13. An image forming apparatus, comprising:
a recording member that records images on media; and
the postprocessing device according to claim 4 that performs postprocessing on media discharged from the recording member.

14. An image forming apparatus, comprising:
a recording member that records images on media; and
the postprocessing device according to claim 5 that performs postprocessing on media discharged from the recording member.

15. An image forming apparatus, comprising:
a recording member that records images on media; and
the postprocessing device according to claim 6 that performs postprocessing on media discharged from the recording member.

16. An image forming apparatus, comprising:
a recording member that records images on media; and
the postprocessing device according to claim 7 that performs postprocessing on media discharged from the recording member.

17. An image forming apparatus, comprising:
a recording member that records images on media; and
the postprocessing device according to claim 8 that performs postprocessing on media discharged from the recording member.

18. An image forming apparatus, comprising:
a recording member that records images on media; and
the postprocessing device according to claim 9 that performs postprocessing on media discharged from the recording member.

19. A postprocessing device comprising:
binding means for binding media;
guided means disposed at the binding means;
guide means for guiding the guided means disposed at the binding means, the guide means including a first guide portion that extends in a width direction of the media, a second guide portion that is connected to the first guide portion and extends in a direction inclined with respect to the width direction, and a third guide portion that is connected to the second guide portion and extends in a direction inclined with respect to the direction in which the second guide portion extends; and
control means for controlling movement of the binding means along the guide means, and controlling the binding means to move the guided means in the second guide portion and the third guide portion at a lower speed than when moving the guided means in the first guide portion.
